(19) United States
(12) Patent Application Publication
(10) Pub. No.: US 2016/0048618 A1
(43) Pub. Date: Feb. 18, 2016

(54) MAGNETIZATION ANALYZING APPARATUS, MAGNETIZATION ANALYZING METHOD, AND COMPUTER-READABLE RECORDING MEDIUM

(71) Applicant: FUJITSU LIMITED, Kawasaki-shi (JP)

(72) Inventor: Koichi Shimizu, Inagi (JP)

(21) Appl. No.: 14/753,054

(22) Filed: Jun. 29, 2015

(30) Foreign Application Priority Data
Aug. 14, 2014 (JP) 2014-165285

(51) Int. Cl. G06F 17/50; G06F 17/16

(52) U.S. Cl. CPC G06F 17/5018; G06F 17/16

(57) ABSTRACT

A magnetization analyzing apparatus calculates a solution of a system of equations for magnetic field by iterative calculation. The magnetization analyzing apparatus includes a processor configured to execute a process including: acquiring a preconditioner by decomposing a coefficient matrix included in the system of equations; and calculating a value of a parameter for adjusting values of diagonal components of the acquired preconditioner based on binary search so that values of diagonal components of the preconditioner become positive by using the parameter.

### CROSS-REFERENCE TO RELATED APPLICATION

This application is based upon and claims the benefit of priority of the prior Japanese Patent Application No. 2014-165285, filed on Aug. 14, 2014, the entire contents of which are incorporated herein by reference.

### FIELD

The embodiments discussed herein are related to a magnetization analyzing apparatus, a magnetization analyzing method, and a computer-readable recording medium.

### BACKGROUND

In numerical simulation using a computer, a technology called discretization is used to express a field in a finite number of physical quantities. Methods for this discretization include, for example, a finite difference method, a finite element method, and a finite volume method. In any of these discretization methods, a finite number of physical quantities are placed in space, and a system of equations is created by discretizing equations that govern a physical phenomenon. Then, a physical quantity is determined by causing a computer to solve the system of equations.

When a system of equations is expressed by a matrix and vectors, this matrix is referred to as a coefficient matrix. There are various systems of equations handled in numerical simulation; zero may be present in a diagonal component of a coefficient matrix. Furthermore, a solution of a system of equations may be impossible or indeterminate.

A system of equations created in the course of magnetic field analysis using an edge element is indeterminate. The edge element is, for example, an element used in a finite element method. It is difficult to find a solution of an indeterminate system of equations by application of a linear solver for a direct solution method. However, a solver for an iterative method using Krylov subspace, such as a conjugate gradient (CG) method or a biconjugate gradient (BiCG) method, can find a solution of an indeterminate system of equations.

Techniques for preconditioning the CG method and the BiCG method are referred to as an incomplete Cholesky conjugate gradient (ICCG) method and an incomplete LU factorization (ILU BiCG) method, respectively. The ICCG method and the ILU BiCG method can reduce the number of iterations taken to be convergent by performing the preconditioning.

In processing by the CG method, a solution is found by iterative calculation of a symmetric matrix. FIG. 11 is a diagram illustrating an example of processing by the CG method. As illustrated in FIG. 11, in the processing by the CG method, without preconditioning, a solution is found by iterative calculation of a symmetric matrix. In FIG. 11, A is a symmetric matrix, and components other than A are vectors. Then, x is a solution.

In processing by the ICCG method, after preconditioning, a solution is found by iterative calculation of a symmetric matrix. FIG. 12 is a diagram illustrating an example of processing by the preconditioned CG (ICCG) method. As illustrated in FIG. 12, in the processing by the ICCG method, after calculation of a preconditioner as preconditioning, a solution is found by iterative calculation of a symmetric matrix. In FIG. 12, C is a preconditioner, A is a symmetric matrix, and components other than A are vectors. Then, x is a solution.

Calculation of a preconditioner C when A is a symmetric matrix is represented by the following equation (1). The matrix C obtained by incomplete Cholesky decomposition of the symmetric matrix A is an approximation of the symmetric matrix A.

$$( \begin{matrix}{A}_{11} & {A}_{12} & & {A}_{1 n} \\ {A}_{21} & {A}_{22} & & \\ ⋮ & & ⋮ & \\ {A}_{n 1} & & & {A}_{nn}\end{matrix} ) = ( \begin{matrix}1 & & & 0 \\ {L}_{21} & 1 & & ⋮ \\ ⋮ & & ⋮ & \\ {L}_{n 1} & {L}_{n 2} & & 1\end{matrix} ) ( \begin{matrix}{D}_{11} & & & 0 \\ & {D}_{22} & & \\ & & ⋮ & \\ 0 & & & {D}_{nn}\end{matrix} ) ( \begin{matrix}1 & {L}_{21} & ⋮ & {L}_{m 1} \\ & 1 & & {L}_{n 2} \\ & & ⋮ & ⋮ \\ 0 & & & 1\end{matrix} ) \qquad ( 1 )$$

According to equation (1), the preconditioner C is represented by a non-diagonal component matrix L, a diagonal component matrix D, and a transposed matrix L^{T} of the non-diagonal component matrix L.

A diagonal component of the matrix D is represented by the following equation (2).

$${D}_{ii} = {A}_{ii} - {\sum }_{k = 1}^{i - 1} {L}_{ik} {D}_{kk} {L}_{ik} \qquad ( 2 )$$

A non-diagonal component of the matrix L is represented by the following equation (3).

$${L}_{ij} = ( {A}_{ij} - {\sum }_{k = 1}^{i - 1} {L}_{ik} {D}_{kk} {L}_{ik} ) / {D}_{jj} \qquad ( 3 )$$

Incidentally, methods to find a solution by iterative calculation of a symmetric matrix include the BiCG method, a BiCG Stab method, a CGS method, a CR method, etc.

In processing by the CR method, a solution is found by iterative calculation of an asymmetric matrix. FIG. 13 is a diagram illustrating an example of processing by the CR method. As illustrated in FIG. 13, in the processing by the CR method, without preconditioning, a solution is found by iterative calculation of an asymmetric matrix. In FIG. 13, A is an asymmetric matrix, and components other than A are vectors. Then, x is a solution.

In processing by an ILU CR method, after preconditioning, a solution is found by iterative calculation of an asymmetric matrix. FIG. 14 is a diagram illustrating an example of processing by the preconditioned CR (ILU CR) method. As illustrated in FIG. 14, in the processing by the ILU CR method, after calculation of a preconditioner as preconditioning, a solution is found by iterative calculation of an asymmetric matrix. In FIG. 14, C is a preconditioner, A is an asymmetric matrix, and components other than A are vectors. Then, x is a solution.

Calculation of a preconditioner C when A is an asymmetric matrix is represented by the following equation (4). The matrix C obtained by incomplete LU decomposition of the asymmetric matrix A is an approximation of the asymmetric matrix A.

$$( \begin{matrix}{A}_{11} & {A}_{12} & & {A}_{1 n} \\ {A}_{21} & {A}_{22} & & \\ ⋮ & & ⋮ & \\ {A}_{n 1} & & & {A}_{nn}\end{matrix} ) = ( \begin{matrix}1 & & & 0 \\ {L}_{21} & 1 & & ⋮ \\ ⋮ & & ⋮ & \\ {L}_{n 1} & {L}_{n 2} & & 1\end{matrix} ) ( \begin{matrix}{D}_{11} & & & 0 \\ & {D}_{22} & & \\ & & ⋮ & \\ 0 & & & {D}_{nn}\end{matrix} ) ( \begin{matrix}1 & {U}_{21} & ⋮ & {U}_{1 n} \\ & 1 & & {U}_{2 n} \\ & & ⋮ & ⋮ \\ 0 & & & 1\end{matrix} ) \qquad ( 4 )$$

According to equation (4), the preconditioner C is represented by a non-diagonal component matrix L, a diagonal component matrix D, and a non-diagonal component matrix U.

A diagonal component of the matrix D is represented by the following equation (5).

$${D}_{ii} = {A}_{ii} - {\sum }_{k = 1}^{i - 1} {L}_{ik} {D}_{kk} {U}_{ki} \qquad ( 5 )$$

A non-diagonal component of the matrix L is represented by the following equation (6).

$${L}_{ij} = ( {A}_{ij} - {\sum }_{k = 1}^{i - 1} {L}_{ik} {D}_{kk} {U}_{ik} ) / D \qquad ( 6 )$$

A non-diagonal component of the matrix U is represented by the following equation (7).

$${U}_{ij} = ( {A}_{ii} - {\sum }_{k = 1}^{i - 1} {L}_{ik} {D}_{kk} {U}_{kj} ) / D \qquad ( 7 )$$

Incidentally, when diagonal components Dᵢᵢ of the preconditioner C are calculated by using a coefficient matrix A of a system of equations generated in the course of magnetic field analysis using an edge element, zero or negative components arise. When zero or negative components have arisen, the preconditioning fails, and therefore the subsequent iterative calculation diverges. The preconditioner C is an approximation of the coefficient matrix A, and therefore can be adjusted by some sort of parameter.

There is known a method to adjust diagonal components Dᵢᵢ with respect to all i so as not to be equal to or less than zero by using a coefficient γ greater than 1 like the following equation (8) or (9). Equation (8) is an adjustment method in the case of the CG method. Equation (9) is an adjustment method in the case of the CR method. Incidentally, the coefficient γ is referred to as a shift parameter.

$$\begin{matrix}{D}_{ii} = γ {A}_{ii} - {\sum }_{k = 1}^{i - 1} {L}_{ik} {D}_{kk} {L}_{ik} ( 1 < γ ) ( Case of CG method ) & ( 8 ) \\ {D}_{ii} = γ {A}_{ii} - {\sum }_{k = 1}^{i - 1} {L}_{ik} {D}_{kk} {U}_{ki} ( 1 < γ ) ( Case of CR method ) & ( 9 )\end{matrix}$$

A value of the shift parameter γ affects the number of iterations for solving a system of equations; therefore, by adjusting the shift parameter γ appropriately, the calculation time can be reduced considerably. As a value of the shift parameter γ, a suitably-large value (1.02 to 1.2) is used empirically.

Patent Document 1: Japanese Laid-open Patent Publication No. 2012-247973

Patent Document 2: International Publication Pamphlet No. WO 2008/026261

Patent Document 3: Japanese Laid-open Patent Publication No. 2012-073681

In regard to a shift parameter used to stabilize preconditioning of a system of equations for magnetic field analysis, there is a problem that an appropriate value of the shift parameter is not calculated at high speed. Diagonal components Dᵢᵢ with respect to all i need to be positive; however, if the diagonal components Dᵢᵢ are too large, the number of iterations for convergence in the subsequent iterative calculation increases. Therefore, it is important to determine a shift parameter by which values of diagonal components Dᵢᵢ become slightly larger than zero at high speed.

According to one embodiment, it is possible to calculate an appropriate value of shift parameter used in preconditioning of a system of equations for magnetic field analysis at high speed.

### SUMMARY

According to an aspect of the embodiments, a magnetization analyzing apparatus calculates a solution of a system of equations for magnetic field by iterative calculation. The magnetization analyzing apparatus includes a processor configured to execute a process including: acquiring a preconditioner by decomposing a coefficient matrix included in the system of equations; and calculating a value of a parameter for adjusting values of diagonal components of the acquired preconditioner based on binary search so that values of diagonal components of the preconditioner become positive by using the parameter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of a magnetization analyzing apparatus according to a first embodiment;

FIG. 2 is a diagram for explaining a system of equations for magnetic field;

FIG. 3 is a diagram illustrating a relationship between a diagonal component Dᵢᵢ of a preconditioner and a shift parameter γ;

FIG. 4 is a diagram illustrating a binary search algorithm used to calculate a shift parameter in the absence of a circuit;

FIG. 5 is a diagram illustrating a binary search algorithm used to calculate a shift parameter in the presence of a circuit;

FIG. 6 is a flowchart illustrating a shift-parameter calculating process according to the first embodiment;

FIG. 7A is a diagram illustrating an example of the number of iterations when an adjustment parameter η and a threshold ε are independent of each other;

FIG. 7B is a diagram illustrating an example of the number of iterations when the adjustment parameter η and the threshold ε are connected with each other;

FIG. 8 is a functional block diagram illustrating a configuration of a magnetization analyzing apparatus according to a second embodiment;

FIG. 9 is a diagram illustrating an example of sharing among CPUs when performing parallel computation;

FIG. 10 is a diagram illustrating an example of a computer that executes a magnetization analyzing program;

FIG. 11 is a diagram illustrating an example of processing by a CG method;

FIG. 12 is a diagram illustrating an example of processing by a preconditioned CG (ICCG) method;

FIG. 13 is a diagram illustrating an example of processing by a CR method; and

FIG. 14 is a diagram illustrating an example of processing by a preconditioned CR (ILU CR) method.

### DESCRIPTION OF EMBODIMENTS

Preferred embodiments will be explained with reference to accompanying drawings. Incidentally, the magnetization analyzing apparatus is an apparatus that calculates a solution of a system of equations generated in the course of magnetic field analysis by iterative calculation, and there is described a case where the magnetization analyzing apparatus is applied to a preconditioned CG method (an ICCG method) or a preconditioned CR method (an ILU CR method). Furthermore, the present invention is not limited to the embodiments described below, and can be broadly applied to magnetic field analysis.

### [a] First Embodiment

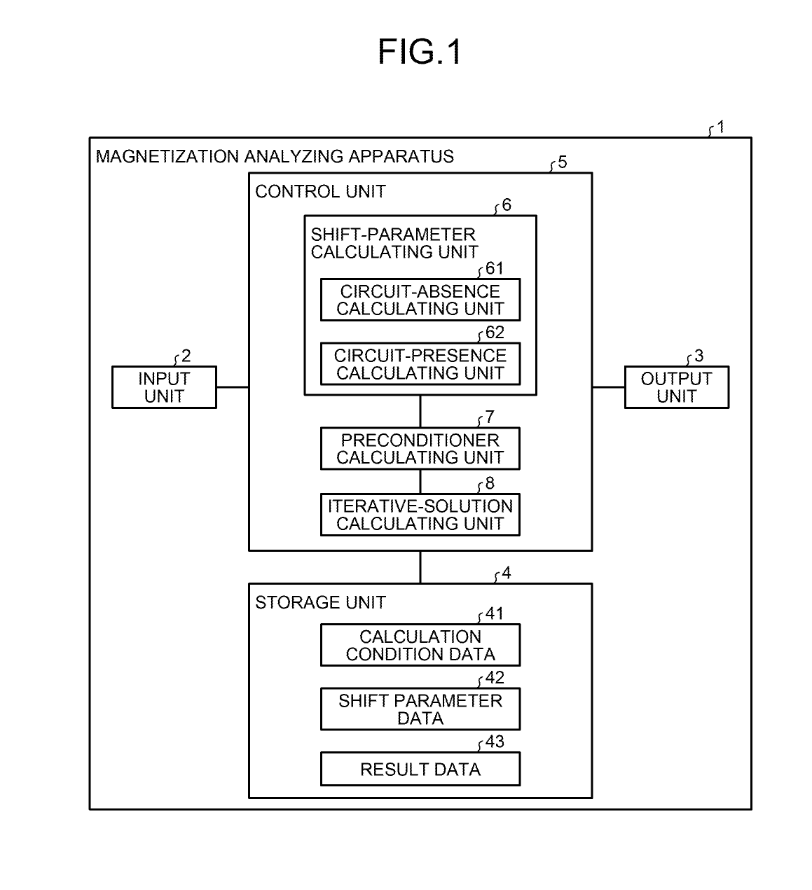

FIG. 1 is a functional block diagram illustrating a configuration of a magnetization analyzing apparatus according to a first embodiment. As illustrated in FIG. 1, a magnetization analyzing apparatus 1 includes an input unit 2, an output unit 3, a storage unit 4, and a control unit 5.

The input unit 2 is an input device for a user who performs analysis to input a variety of information or an instruction to the magnetization analyzing apparatus 1. For example, the input unit 2 corresponds to a keyboard, a mouse, and a touch panel. The output unit 3 is an output device that displays thereon a variety of information. For example, the output unit 3 corresponds to a display and a touch panel.

The storage unit 4 is a semiconductor memory device, such as a RAM and a flash memory, or a storage device, such as a hard disk and an optical disk. The storage unit 4 stores therein calculation condition data 41, shift parameter data 42, and result data 43.

The calculation condition data 41 is data on calculation conditions for magnetization analysis. The calculation condition data 41 includes, for example, a coefficient matrix used to generate a preconditioner and various constants used to calculate a shift parameter.

The coefficient matrix here is a sparse matrix included in a system of equations generated in the course of magnetic field analysis by a finite element method. The preconditioner is an approximation of the coefficient matrix. The coefficient matrix includes a symmetric matrix and an asymmetric matrix. The shift parameter is a parameter for adjusting values of diagonal components of the preconditioner. That is, in the ICCG method, a shift parameter is a parameter for adjusting diagonal components Dᵢᵢ of the preconditioner in equation (2) so that values of the diagonal components Dᵢᵢ are slightly larger than zero. In the ILU CR method, a shift parameter is a parameter for adjusting diagonal components Dᵢᵢ of the preconditioner in equation (5) so that values of the diagonal components Dᵢᵢ are slightly larger than zero. Incidentally, the coefficient matrix is denoted by code “A” appropriately. The preconditioner is denoted by code “C” appropriately. The shift parameter is denoted by code “γ” appropriately.

The shift parameter data 42 is data on a shift parameter.

The result data 43 is data indicating a calculation result of a solution of a system of equations generated in the course of magnetic field analysis found by iterative calculation. The result data 43 includes the solution of the system of equations for magnetic field.

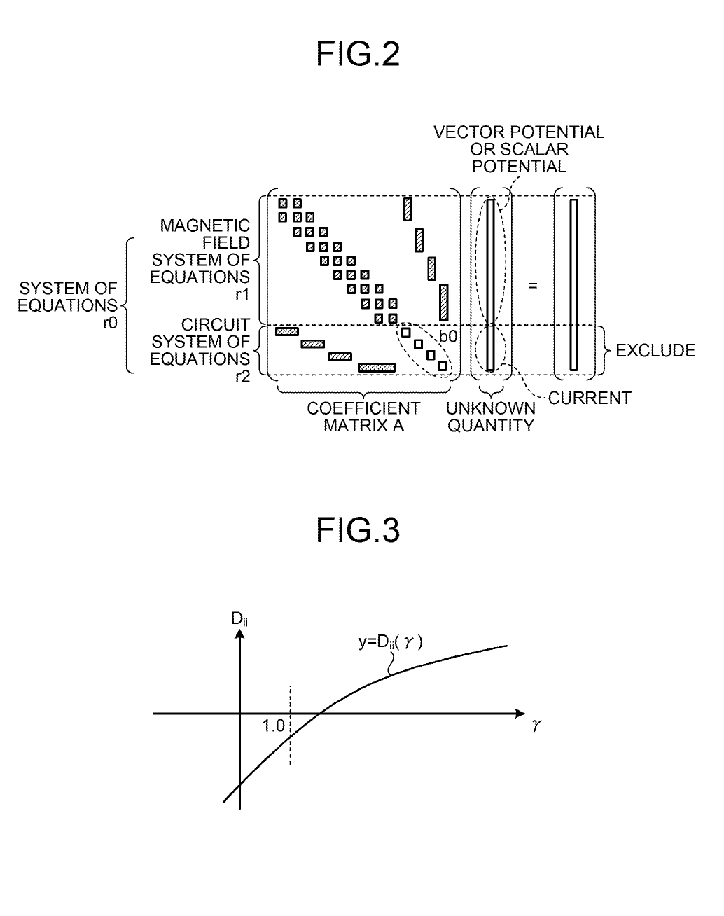

Here, the system of equations for magnetic field is explained with reference to FIG. 2. FIG. 2 is a diagram for explaining the system of equations for magnetic field. As illustrated in FIG. 2, a system of equations r0 includes a system of equations r1 for magnetic field generated in the course of magnetic field analysis by a finite element method and a system of equations r2 for circuit. Rectangular black-painted areas of a coefficient matrix A indicate that a value thereof is not zero. Rectangular white-painted areas and empty space of the coefficient matrix A indicate that a value thereof is zero. The system of equations r0 has been rearranged so that an upper part of the coefficient matrix A is an area of vector potential or scalar potential (iεX) which is the unknown quantity of the system of equations r1 for magnetic field. Furthermore, the system of equations r0 has been rearranged so that a lower part of the coefficient matrix A is an area of current (iεY) which is the unknown quantity of the system of equations r2 for circuit. The unknown quantity is a solution of the system of equations. The term i here is a specific row number in all degrees of freedom. The term X here is a set of row numbers of which the vector potential or scalar potential is the unknown quantity. The term Y here is a set of row numbers of which the current is the unknown quantity.

The shift parameter γ adjusts diagonal components Aᵢᵢ of the coefficient matrix A (see equations (8) and (9)). When the system of equations r0 includes the system of equations r2 for circuit, a diagonal component Aᵢᵢ (b0) of a row of which the current is the unknown quantity in the coefficient matrix A included in the system of equations r0 is zero. In such a case, no matter how large a value of shift parameter γ the diagonal components of the coefficient matrix A are multiplied by, the diagonal components Dᵢᵢ of the preconditioner C never be positive. This is because according to equation (8) in the case of the ICCG method or equation (9) in the case of the ILU CR method, the diagonal components Dᵢᵢ of the preconditioner C become negative or zero. Accordingly, when the system of equations r0 includes the system of equations r2 for circuit, the shift parameter γ is calculated so that Dᵢᵢ, excluding ones placed in rows of which the current is the unknown quantity, are positive.

To return to FIG. 1, the control unit 5 corresponds to an electronic circuit such as a central processing unit (CPU). Then, the control unit 5 has an internal memory for storing programs defining various processing procedures and control data, and executes various processing using these programs and data. For example, the control unit 5 executes a magnetization analyzing process. The magnetization analyzing process includes reading the calculation condition data 41 from the storage unit 4 and starting calculation. The magnetization analyzing process further includes, in the calculation process, calculating a shift parameter by using a coefficient matrix of the calculation condition data 41 and storing the calculated shift parameter as data for adjusting a preconditioner (shift parameter data 42) in the storage unit 4. The magnetization analyzing process still further includes finding a solution of a system of equations for magnetic field by iterative calculation using the shift parameter.

The control unit 5 includes a shift-parameter calculating unit 6, a preconditioner calculating unit 7, and an iterative-solution calculating unit 8. The shift-parameter calculating unit 6 calculates a shift parameter to adjust diagonal components of a preconditioner approximating a coefficient matrix of calculation condition data 41 so as to have a positive value slightly larger than zero. The shift-parameter calculating unit 6 stores the calculated shift parameter as shift parameter data 42 in the storage unit 4.

The shift-parameter calculating unit 6 includes a circuit-absence calculating unit 61 and a circuit-presence calculating unit 62.

The circuit-absence calculating unit 61 calculates a shift parameter when the system of equations r0 does not include the system of equations r2 for circuit. For example, the circuit-absence calculating unit 61 acquires a preconditioner by decomposing a coefficient matrix composing a system of equations for magnetic field. This mode of acquiring a preconditioner includes acquiring a preconditioner by calculating a coefficient matrix composing a system of equations for magnetic field. The decomposition of a coefficient matrix means, for example, incomplete Cholesky decomposition in the case of the ICCG method or incomplete LU decomposition in the case of the ILU CR method. The circuit-absence calculating unit 61 calculates a shift parameter based on the binary search method so that diagonal components of a preconditioner are all positive.

Here, a relationship between diagonal components of a preconditioner and a shift parameter is explained with reference to FIG. 3. Diagonal components Dᵢᵢ of a preconditioner are represented, for example, by equation (8) or (9), and are found by a monotonically increasing function with respect to a shift parameter γ. This function is set as a function of shift parameter γ, and is denoted by Dᵢᵢ(γ).

FIG. 3 is a diagram illustrating a relationship between a diagonal component Dᵢᵢ of a preconditioner and a shift parameter γ. Incidentally, the X-axis indicates a value of a shift parameter γ, and the Y-axis indicates a value of a diagonal component Dᵢᵢ. As illustrated in FIG. 3, as the shift parameter γ increases, the diagonal component Dᵢᵢ monotonically increases.

To return to FIG. 1, for example, the circuit-absence calculating unit 61 sets a value of shift parameter γ by which a diagonal component Dᵢᵢ is likely to become negative as a minimum value γₘᵢₙ. For example, in the case of the function illustrated in FIG. 3, when a value of shift parameter γ is 1, Dᵢᵢ is negative, so the minimum value γₘᵢₙ can be set to 1.0. The circuit-absence calculating unit 61 sets a value of shift parameter γ by which a diagonal component Dᵢᵢ inevitably becomes positive as a maximum value γₘₐₓ. That is, if Dᵢᵢ(γₘᵢₙ) is negative and Dᵢᵢ (γₘₐₓ) is positive, a shift parameter γ by which Dᵢᵢ becomes 0 is present in between γₘᵢₙ and γₘₐₓ. Accordingly, the circuit-absence calculating unit 61 calculates a shift parameter γ by which Dᵢᵢ approximates zero based on the binary search method. The circuit-absence calculating unit 61 finishes the binary search when a difference between γₘᵢₙ and γₘₐₓ has become smaller than a threshold ε.

The threshold ε here is set based on a linear equation ε=kη (0<k<1) with respect to an adjustment parameter η which is a parameter for adjusting a shift parameter. For example, standard values of η and ε can be set to 0.02 and 1.0×10⁻³, respectively. The circuit-absence calculating unit 61 can speed up the calculation by adjusting the standard values.

Upon completion of the binary search, the circuit-absence calculating unit 61 calculates a shift parameter γ based on equation (10) using the adjustment parameter η, γₘᵢₙ and γₘₐₓ. That is, the circuit-absence calculating unit 61 calculates, as a value of shift parameter γ, a value obtained by multiplying a parameter in between γₘᵢₙ and γₘₐₓ by a value (1.0+η) obtained by adding the adjustment parameter η to 1.0. Incidentally, t is a numerical value in between 0 and 1.0; for example, t is 0.5, but is not limited to this.

γ=(1.0+η)(tγₘᵢₙ+(1.0−t)γₘₐₓ) (10)

The reason why equation (10) is used as an equation for calculating a shift parameter γ here is as follows. A value of k in the linear equation for threshold ε=kη is set to any value which meets 0<k<1. When the adjustment parameter η is larger than a prescribed value, the threshold ε becomes a larger value by the linear equation for threshold ε=kη. If the threshold ε is a larger value, the number of binary searches is reduced; therefore, a value of a second equation (tγₘᵢₙ+(1.0−t)γₘₐₓ) in the right-hand member of equation (10) becomes a value smaller than an intended value. Then, a value of a first equation (1.0+η) in the right-hand member becomes a larger value by the adjustment parameter η; therefore, even if a value of the second equation becomes smaller than the intended value, eventually, a value of shift parameter γ is not a small value and can be a positive value slightly larger than zero. On the other hand, when the adjustment parameter η is smaller than the prescribed value, the threshold ε becomes a smaller value by the linear equation for threshold ε=kη. If the threshold ε is a smaller value, a value of the second equation becomes a value closer to the intended value; therefore, even if a value of the first equation becomes a smaller value, eventually, a value of shift parameter γ is not a small value and can be a positive value slightly larger than zero. Therefore, by using equation (10) as an equation for calculating a shift parameter γ, an appropriate shift parameter can be calculated, and it is possible to maintain the convergence in the subsequent iterative calculation of a system of equations for magnetic field analysis.

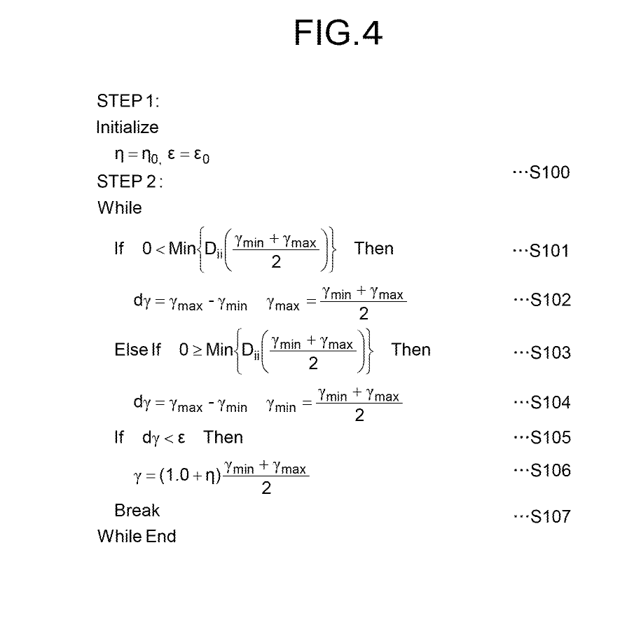

Here, a binary search algorithm used to calculate a shift parameter γ when the system of equations r0 does not include the system of equations r2 for circuit is explained. FIG. 4 is a diagram illustrating a binary search algorithm used to calculate a shift parameter in the absence of a circuit. Incidentally, it is assumed that first, the circuit-absence calculating unit 61 has determined a value of shift parameter γ by which Dᵢᵢ is likely to become negative as a minimum value γₘᵢₙ and a value of shift parameter γ by which Dᵢᵢ inevitably becomes positive as a maximum value γₘₐₓ.

As illustrated in FIG. 4, as step 1 (an initialization process), the circuit-absence calculating unit 61 sets an initial value η₀ in the adjustment parameter η, and sets an initial value ε₀ in the threshold ε (S100).

As step 2, the circuit-absence calculating unit 61 calculates a minimum value of Dᵢᵢ corresponding to an intermediate value (γₘᵢₙ+γₘₐₓ)/2 of the currently-set minimum value γₘᵢₙ and the currently-set maximum value γₘₐₓ. When the calculated minimum value Dᵢᵢ is larger than zero (S101), the circuit-absence calculating unit 61 performs the following process. That is, the circuit-absence calculating unit 61 calculates a difference dγ between the currently-set minimum value γₘᵢₙ and the currently-set maximum value γₘₐₓ. The circuit-absence calculating unit 61 sets the intermediate value (γₘᵢₙ+γₘₐₓ)/2 of the currently-set minimum value γₘᵢₙ and the currently-set maximum value γₘₐₓ as a new maximum value γₘₐₓ (S102). That is, to narrow down the search range of a shift parameter γ to half, the circuit-absence calculating unit 61 sets the maximum value γₘₐₓ in a direction in which a value of Dᵢᵢ becomes smaller. In other words, the circuit-absence calculating unit 61 sets the maximum value γₘₐₓ in a direction in which a value of Dᵢᵢ is positive and close to zero.

On the other hand, when the calculated minimum value Dᵢᵢ is equal to or smaller than zero (S103), the circuit-absence calculating unit 61 performs the following process. That is, the circuit-absence calculating unit 61 calculates a difference dγ between the currently-set minimum value γₘᵢₙ and the currently-set maximum value γₘₐₓ. The circuit-absence calculating unit 61 sets the intermediate value (γₘᵢₙ+γₘₐₓ)/2 of the currently-set minimum value γₘᵢₙ and the currently-set maximum value γₘₐₓ as a new minimum value γₘᵢₙ (S104). That is, to narrow down the search range of a shift parameter γ to half, the circuit-absence calculating unit 61 sets the minimum value γₘᵢₙ in a direction in which a value of Dᵢᵢ becomes larger.

Then, when the difference dγ is smaller than the threshold ε (S105), the circuit-absence calculating unit 61 calculates a shift parameter γ based on equation (10). Here, t in equation (10) is set to 0.5. That is, the circuit-absence calculating unit 61 calculates a value obtained by multiplying the intermediate value of the currently-set minimum value γₘᵢₙ and the currently-set maximum value γₘₐₓ by a value larger than 1 (1.0+η) as a value of shift parameter γ (S106).

On the other hand, when the difference dγ is equal to or larger than the threshold ε (S107), the circuit-absence calculating unit 61 moves on to S101 to repeat the binary search using the currently-set maximum and minimum values γₘₐₓ and γₘᵢₙ.

To return to FIG. 1, the circuit-presence calculating unit 62 calculates a shift parameter when the system of equations r0 includes the system of equations r2 for circuit. For example, the circuit-presence calculating unit 62 acquires a preconditioner by decomposing a coefficient matrix composing a system of equations for magnetic field. This mode of acquiring a preconditioner includes acquiring a preconditioner by calculating a coefficient matrix composing a system of equations for magnetic field. The decomposition of a coefficient matrix is the same as that by the circuit-absence calculating unit 61, so description is omitted. The circuit-presence calculating unit 62 calculates a shift parameter based on the binary search method so that diagonal components by excluding ones placed in rows for circuit out of diagonal components of the preconditioner, are all positive. This is because diagonal components placed in rows for circuit are zero (see b0 in FIG. 2), so according to equation (8) in the case of the ICCG method or equation (9) in the case of the ILU CR method, the diagonal components Dᵢᵢ of the preconditioner C become negative or zero.

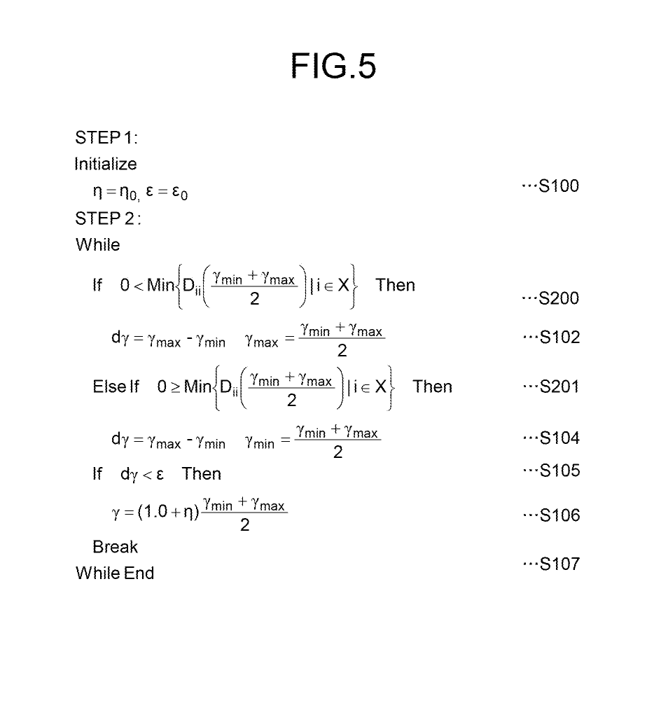

Here, a binary search algorithm used to calculate a shift parameter γ when the system of equations r0 includes the system of equations r2 for circuit is explained. FIG. 5 is a diagram illustrating a binary search algorithm used to calculate a shift parameter in the presence of a circuit. Incidentally, the same process as the binary search algorithm used when the system of equations r0 does not include the system of equations r2 for circuit is denoted by the same reference numeral. Furthermore, it is assumed that first, the circuit-presence calculating unit 62 has determined a value of shift parameter γ by which Dᵢᵢ is likely to become negative as a minimum value γₘᵢₙ and a value of shift parameter γ by which Dᵢᵢ inevitably becomes positive as a maximum value γₘₐₓ.

As illustrated in FIG. 5, as step 1 (an initialization process), the circuit-presence calculating unit 62 sets an initial value ηₕₒ in η as an adjustment parameter, and sets an initial value ε₀ in the threshold ε as an adjustment parameter (S100).

As step 2, the circuit-presence calculating unit 62 calculates a minimum value (Min) of Dᵢᵢ corresponding to an intermediate value (γₘᵢₙ+γₘₐₓ)/2 of the currently-set minimum value γₘᵢₙ and the currently-set maximum value γₘₐₓ. The term “iεX” here means a row number i belongs to a set of row numbers of which the vector potential or scalar potential is the unknown quantity. Therefore, only a row number i of which the vector potential or scalar potential is the unknown quantity is used, and rows of circuit, i.e., row numbers i of which the current is the unknown quantity is excluded. When the calculated minimum value Dᵢᵢ is larger than zero (S200), the circuit-presence calculating unit 62 performs the following process.

That is, the circuit-presence calculating unit 62 calculates a difference dγ between the currently-set minimum value γₘᵢₙ and the currently-set maximum value γₘₐₓ. The circuit-presence calculating unit 62 sets the intermediate value (γₘᵢₙ+γₘₐₓ)/2 of the currently-set minimum value γₘᵢₙ and the currently-set maximum value γₘₐₓ as a new maximum value γₘₐₓ (S102). That is, to narrow down the search range of a shift parameter γ to half, the circuit-presence calculating unit 62 sets the maximum value γₘₐₓ in a direction in which a value of Dᵢᵢ becomes smaller. In other words, the circuit-presence calculating unit 62 sets the maximum value γₘₐₓ in a direction in which a value of Dᵢᵢ is positive and close to zero.

On the other hand, when the calculated minimum value Dᵢᵢ is equal to or smaller than zero (S201), the circuit-presence calculating unit 62 performs the following process. That is, the circuit-presence calculating unit 62 calculates a difference dγ between the currently-set minimum value γₘᵢₙ and the currently-set maximum value γₘₐₓ. The circuit-presence calculating unit 62 sets the intermediate value (γₘᵢₙ+γₘₐₓ)/2 of the currently-set minimum value γₘᵢₙ and the currently-set maximum value γₘₐₓ as a new minimum value γₘᵢₙ (S104). That is, to narrow down the search range of a shift parameter γ to half, the circuit-presence calculating unit 62 sets the minimum value γₘᵢₙ in a direction in which a value of Dᵢᵢ becomes larger.

Then, when the difference dγ is smaller than the threshold ε (S105), the circuit-presence calculating unit 62 calculates a shift parameter γ based on equation (10). Here, t in equation (10) is set to 0.5. That is, the circuit-presence calculating unit 62 calculates a value obtained by multiplying the intermediate value of the currently-set minimum value γₘᵢₙ and the currently-set maximum value γₘₐₓ by a value larger than 1 (1.0+η) as a value of shift parameter γ (S106).

On the other hand, when the difference dγ is equal to or larger than the threshold ε (S107), the circuit-presence calculating unit 62 moves on to S200 to repeat the binary search using the currently-set maximum and minimum values γₘₐₓ and γₘᵢₙ.

To return to FIG. 1, the preconditioner calculating unit 7 calculates a preconditioner based on a shift parameter calculated by the shift-parameter calculating unit 6. For example, the preconditioner calculating unit 7 reads shift parameter data 42 from the storage unit 4.

As an example, in the case of the ICCG method, the preconditioner calculating unit 7 calculates a diagonal component Dᵢᵢ of a matrix D by using equation (8). The preconditioner calculating unit 7 calculates a non-diagonal component Lᵢⱼ of a matrix L by substituting the calculated diagonal component Dᵢᵢ of the matrix D into equation (3). The preconditioner calculating unit 7 calculates a preconditioner C by substituting the calculated diagonal component Dᵢᵢ of the matrix D and the calculated non-diagonal component Lᵢⱼ of the matrix L into equation (1).

As another example, in the case of the ILU CR method, the preconditioner calculating unit 7 calculates a diagonal component Dᵢᵢ of a matrix D by using equation (9). The preconditioner calculating unit 7 calculates a non-diagonal component Lᵢⱼ by substituting the calculated diagonal component Dᵢᵢ of the matrix D into equation (6). The preconditioner calculating unit 7 calculates a non-diagonal component Uᵢⱼ by substituting the calculated diagonal component Dᵢᵢ of the matrix D into equation (7). The preconditioner calculating unit 7 calculates a preconditioner C by substituting the calculated diagonal component Dᵢᵢ of the matrix D, the calculated non-diagonal component Lᵢⱼ, and the calculated non-diagonal component Uᵢⱼ into equation (4).

The iterative-solution calculating unit 8 calculates a solution of a system of equations for magnetic field by iterative calculation using the ICCG method or the ILU CR method.

[Procedure of Shift-Parameter Calculating Process]

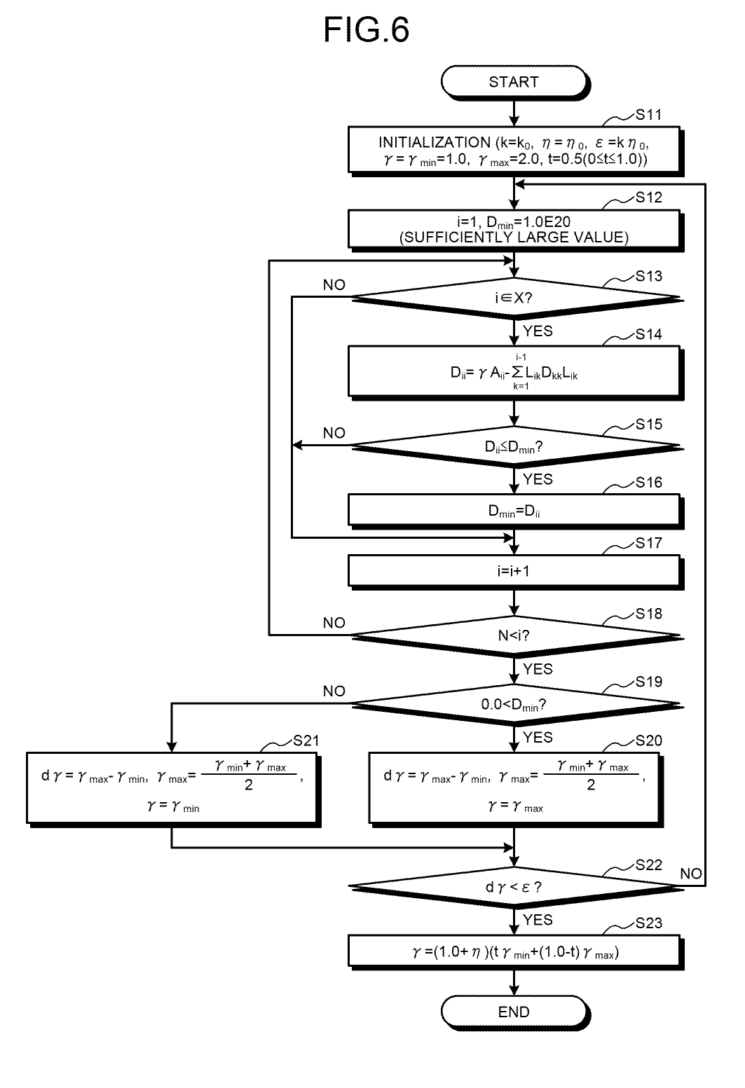

FIG. 6 is a flowchart illustrating a shift-parameter calculating process according to the first embodiment. Incidentally, in FIG. 6, there is explained a shift-parameter calculating process in the presence of a circuit, i.e., in the case where a solution of a system of equations for magnetic field is calculated by iterative calculation. A method to find a solution of a system of equations for magnetic field including a coefficient matrix A is the ICCG method, and a function Dᵢᵢ(γ) of a shift parameter γ is represented by equation (8). Furthermore, in FIG. 6, the total row number of the coefficient matrix A is denoted by N.

As illustrated in FIG. 6, the circuit-presence calculating unit 62 initializes a variable used in the shift-parameter calculating process (Step S11). For example, based on the calculation condition data 41, the circuit-presence calculating unit 62 sets k₀ as an initial value in a variable k, and sets a value obtained by multiplying the variable k by the adjustment parameter η in a threshold ε as an adjustment parameter. The circuit-presence calculating unit 62 sets 1.0 as an initial value in a shift parameter γₘᵢₙ. A value of shift parameter γ by which a diagonal component Dᵢᵢ is likely to become negative is set in In the shift parameter γₘᵢₙ. The circuit-presence calculating unit 62 sets the value of γₘᵢₙ as an initial value of the shift parameter γ. The circuit-presence calculating unit 62 sets 2.0 as an initial value in a shift parameter γₘₐₓ. A value of shift parameter γ by which a diagonal component Dᵢᵢ inevitably becomes positive is set in the shift parameter γₘₐₓ. The circuit-presence calculating unit 62 sets 0.5 as an initial value in a variable t. Incidentally, the variable t is a numerical value in between 0 and 1.0.

The circuit-presence calculating unit 62 sets 1 as an initial value in a row number i, and sets 1.0E20, which is a sufficiently large value, as an initial value in a minimum value Dₘᵢₙ of the diagonal component Dᵢᵢ (Step S12). The circuit-presence calculating unit 62 determines whether the row number i belongs to a set X of row numbers of which the vector potential or scalar potential is the unknown quantity (Step S13).

When having determined that the row number i does not belong to the row number set X (NO at Step S13), the circuit-presence calculating unit 62 proceeds to Step S17 to move to the next row number i. On the other hand, when having determined that the row number i belongs to the row number set X (YES at Step S13), the circuit-presence calculating unit 62 calculates a diagonal component Dᵢᵢ based on the function Dᵢᵢ(γ) in equation (8) (Step S14).

The circuit-presence calculating unit 62 determines whether the diagonal component Dᵢᵢ, which a result of the calculation, is equal to or smaller than Dₘᵢₙ (Step S15). When having determined that the diagonal component Dᵢᵢ, which a result of the calculation, is equal to or smaller than Dₘᵢₙ (YES at Step S15), the circuit-presence calculating unit 62 replaces the value of Dₘᵢₙ with the diagonal component Dᵢᵢ, which a result of the calculation (Step S16). Then, the circuit-presence calculating unit 62 proceeds to Step S17 to move to the next row number i.

On the other hand, when having determined that the diagonal component Dᵢᵢ, which a result of the calculation, is larger than Dₘᵢₙ (NO at Step S15), the circuit-presence calculating unit 62 proceeds to Step S17 to move to the next row number i.

At Step S17, the circuit-presence calculating unit 62 increments the row number i by 1 (Step S17). Then, the circuit-presence calculating unit 62 determines whether the row number i is greater than the total row number N (Step S18). When having determined that the row number i is not greater than the total row number N (NO at Step S18), the circuit-presence calculating unit 62 returns to Step S13 to perform the process on a diagonal component Dᵢᵢ of the row number i.

On the other hand, when having determined that the row number i is greater than the total row number N (YES at Step S18), the circuit-presence calculating unit 62 determines whether Dₘᵢₙ corresponding to the current shift parameter γ, i.e., a minimum value Dₘᵢₙ of Dᵢᵢ is larger than 0.0 (Step S19).

When having determined that Dₘᵢₙ is not larger than 0.0 (NO at Step S19), the circuit-presence calculating unit 62 performs the following process. That is, the circuit-presence calculating unit 62 calculates a difference dγ by subtracting γₘᵢₙ from the currently-set γₘₐₓ. The circuit-presence calculating unit 62 calculates an intermediate value (γₘᵢₙ+γₘₐₓ)/2 of the currently-set γₘₐₓ and γₘᵢₙ, and sets the calculated intermediate value as a new γₘᵢₙ. The circuit-presence calculating unit 62 sets the value of γₘᵢₙ in the shift parameter γ (Step S21). That is, to narrow down the search range of a value of the shift parameter γ to half, the circuit-presence calculating unit 62 sets γₘᵢₙ in a direction in which a value of Dᵢᵢ becomes larger. Then, the circuit-presence calculating unit 62 proceeds to Step S22.

On the other hand, when having determined that Dₘᵢₙ is larger than 0.0 (YES at Step S19), the circuit-presence calculating unit 62 performs the following process. That is, the circuit-presence calculating unit 62 calculates a difference dγ by subtracting γₘᵢₙ from the currently-set γₘₐₓ. The circuit-presence calculating unit 62 calculates an intermediate value (γₘᵢₙ+γₘₐₓ)/2 of the currently-set γₘₐₓ and γₘᵢₙ, and sets the calculated intermediate value as a new γₘₐₓ. The circuit-presence calculating unit 62 sets the value of γₘₐₓ in the shift parameter γ (Step S20). That is, to narrow down the search range of a value of the shift parameter γ to half, the circuit-presence calculating unit 62 sets γₘₐₓ in a direction in which a value of Dᵢᵢ becomes smaller. In other words, the circuit-presence calculating unit 62 sets γₘₐₓ in a direction in which a value of Dᵢᵢ is positive and close to zero. Then, the circuit-presence calculating unit 62 proceeds to Step S22.

At Step S22, the circuit-presence calculating unit 62 determines whether the difference dγ between γₘₐₓ and θₘᵢₙ is smaller than the threshold ε (Step S22). When having determined that the difference dγ is not smaller than the threshold ε (NO at Step S22), the circuit-presence calculating unit 62 returns to Step S12 to perform the process on a diagonal component Dᵢᵢ with respect to the newly-set shift parameter γ.

On the other hand, when having determined that the difference dγ is smaller than the threshold ε (YES at Step S22), the circuit-presence calculating unit 62 calculates a shift parameter γ based on equation (10) (Step S23). That is, the circuit-presence calculating unit 62 calculates a value obtained by multiplying any value in between the currently-set minimum value γₘᵢₙ and the currently-set maximum value γₘₐₓ by a value larger than 1 (1.0+η) as a value of shift parameter γ. Then, the circuit-presence calculating unit 62 ends the shift-parameter calculating process.

### Effects of First Embodiment

According to the above-described first embodiment, the magnetization analyzing apparatus 1 acquires a preconditioner by decomposing a coefficient matrix composing a system of equations generated in the course of magnetic field analysis. This mode of acquiring a preconditioner includes acquiring a preconditioner by calculating a coefficient matrix composing a system of equations for magnetic field. The magnetization analyzing apparatus 1 calculates a value of shift parameter for adjusting values of diagonal components of the acquired preconditioner based on the binary search so that values of diagonal components of the preconditioner become positive by using the shift parameter. According to this configuration, the magnetization analyzing apparatus 1 calculates a value of shift parameter based on the binary search so that values of diagonal components of the preconditioner become positive, and therefore can calculate an appropriate value of shift parameter at high speed. Consequently, the magnetization analyzing apparatus 1 can calculate the system of equations generated in the course of magnetic field analysis stably and at high speed.

Furthermore, according to the above-described first embodiment, when the system of equations includes a circuit-related system of equations, the magnetization analyzing apparatus 1 calculates a value of shift parameter by excluding ones related to the circuit-related system of equations out of diagonal components placed in rows of the coefficient matrix. According to this configuration, values of diagonal components placed in rows related to the circuit are zero, so the magnetization analyzing apparatus 1 calculates a value of shift parameter by excluding diagonal components placed in rows whose value has been found to be zero in advance, and therefore can calculate an appropriate value.

Moreover, according to the above-described first embodiment, the magnetization analyzing apparatus 1 sets the minimum and maximum values of shift parameter in advance. The magnetization analyzing apparatus 1 calculates a minimum value of the diagonal components of the preconditioner corresponding to an intermediate value of the currently-set minimum value of shift parameter and the currently-set maximum value of shift parameter. The magnetization analyzing apparatus 1 calculates a difference between the currently-set minimum value of shift parameter and the currently-set maximum value of shift parameter. When the minimum value of the diagonal components of the preconditioner is larger than zero, the magnetization analyzing apparatus 1 sets the intermediate value of the currently-set minimum value of shift parameter and the currently-set maximum value of shift parameter as a new maximum value of shift parameter; on the other hand, when the minimum value of the diagonal components of the preconditioner is equal to or smaller than zero, the magnetization analyzing apparatus 1 sets the intermediate value of the currently-set minimum value of shift parameter and the currently-set maximum value of shift parameter as a new minimum value of shift parameter. The magnetization analyzing apparatus 1 repeatedly performs the shift-parameter calculating process until the calculated difference becomes smaller than a threshold. According to this configuration, the magnetization analyzing apparatus 1 calculates a value of shift parameter so that values of diagonal components of the preconditioner become positive while narrowing down the search range of a shift parameter to half, and therefore can calculate an appropriate value of shift parameter at high speed.

Furthermore, according to the above-described first embodiment, when the calculated difference is smaller than the threshold, the magnetization analyzing apparatus 1 calculates a value obtained by multiplying a value in between the currently-set minimum and maximum values of shift parameter by a value obtained by adding a value of adjustment parameter to 1 as a value of shift parameter. According to this configuration, the magnetization analyzing apparatus 1 can make a fine adjustment to a value of shift parameter based on the adjustment parameter η.

Moreover, according to the above-described first embodiment, the magnetization analyzing apparatus 1 calculates the threshold ε by using a linear equation ε=kη (0<k<1) for a variable η set as an adjustment parameter in advance. According to this configuration, the magnetization analyzing apparatus 1 calculates the threshold ε by using the adjustment parameter η for making a fine adjustment to a value of shift parameter, and therefore can calculate a more appropriate value of shift parameter. Consequently, the magnetization analyzing apparatus 1 can find a solution of a system of equations for magnetic field stably by the smaller number of iterations.

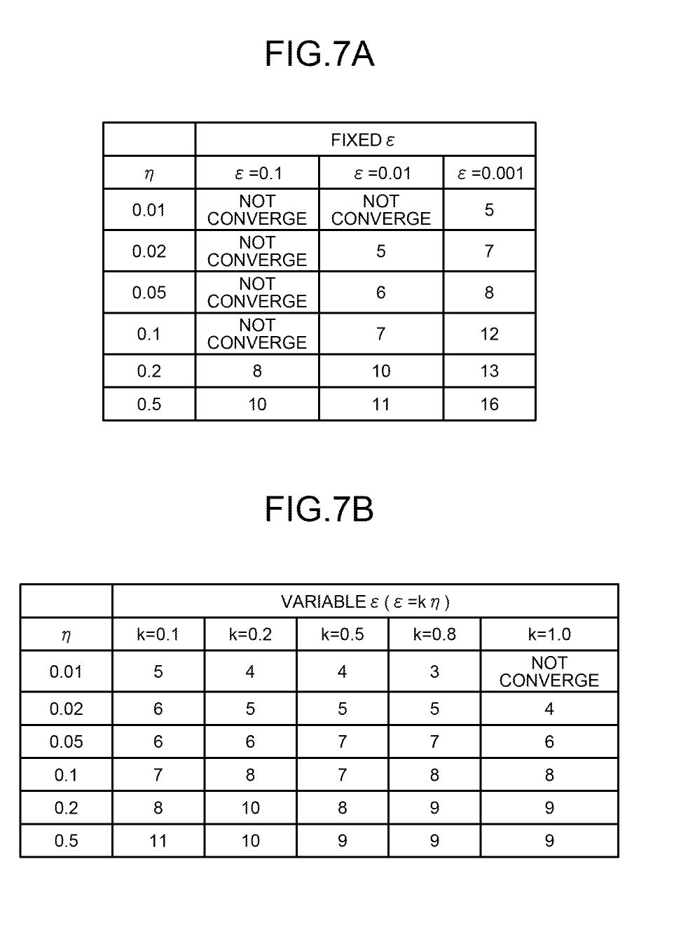

Here, the effect that the magnetization analyzing apparatus 1 can find a solution of a system of equations for magnetic field stably by the smaller number of iterations is explained with reference to FIGS. 7A and 7B. FIG. 7A is a diagram illustrating the number of iterations when the adjustment parameter η and the threshold ε are set independently. FIG. 7B is a diagram illustrating the number of iterations when the adjustment parameter η and the threshold ε are set in conjunction. Incidentally, in FIGS. 7A and 7B, “not converge” means a corresponding shift parameter does not make iterative calculation of a system of equations for magnetic field converge.

The number of iterations when the adjustment parameter η and the threshold ε are set independently is as follows. As illustrated in FIG. 7A, depending on the setting of the threshold ε, it is often the case that the iterative calculation does not converge. Here, when a value of threshold ε is 0.1, the iterative calculation does not converge when a value of adjustment parameter η is 0.01, 0.02, 0.05, or 0.1. Furthermore, when the threshold ε is 0.001, the iterative calculation converges; however, if a value of adjustment parameter η is increased, which leads to a large increase in the number of iterations.

On the other hand, the number of iterations when the adjustment parameter η and the threshold ε are set in conjunction is as follows. As illustrated in FIG. 7B, when the threshold ε is set based on the adjustment parameter η and the linear equation for k, except in a case of k=1.0, the iterative calculation converges invariably. When the smaller number of iterations is considered as less than ten, by setting k within a range of 0.5 to 0.8, a solution of a system of equations for magnetic field can be found stably by the smaller number of iterations.

### [b] Second Embodiment

There is described the case where the magnetization analyzing apparatus 1 according to the first embodiment calculates a shift parameter from a coefficient matrix without using parallel computation. However, the magnetization analyzing apparatus 1 can calculate a shift parameter from a coefficient matrix by using parallel computation.

Accordingly, in a second embodiment, there is described a case where the magnetization analyzing apparatus 1 calculates a shift parameter from a coefficient matrix by using parallel computation.

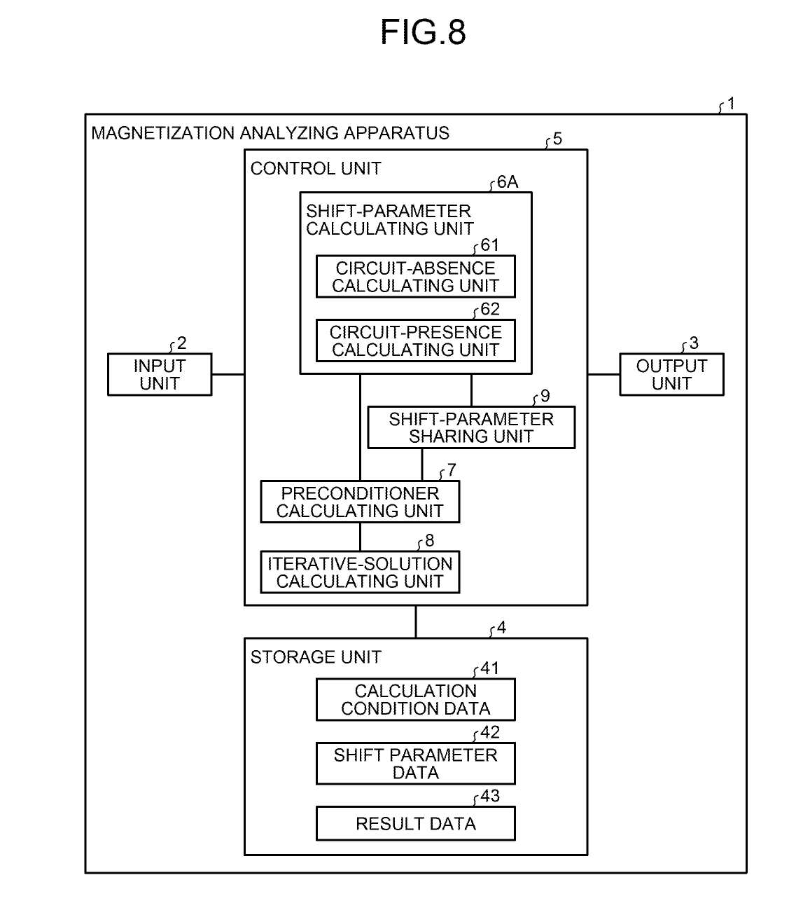

FIG. 8 is a functional block diagram illustrating a configuration of a magnetization analyzing apparatus according to the second embodiment. Incidentally, the same component as that of the magnetization analyzing apparatus 1 illustrated in FIG. 1 is assigned the same reference numeral, and description of the overlapping component and operation is omitted. The second embodiment differs from the first embodiment in that the control unit 5 of the magnetization analyzing apparatus 1 according to the second embodiment includes a shift-parameter calculating unit 6A instead of the shift-parameter calculating unit 6 and further includes a shift-parameter sharing unit 9.

The shift-parameter calculating unit 6A calculates a shift parameter to adjust, out of a coefficient matrix A in calculation condition data 41, an assigned area assigned to a CPU which performs parallel computation so that a value of diagonal component becomes a positive value slightly larger than zero. The shift parameter is calculated with respect to each assigned area by each CPU which performs parallel computation.

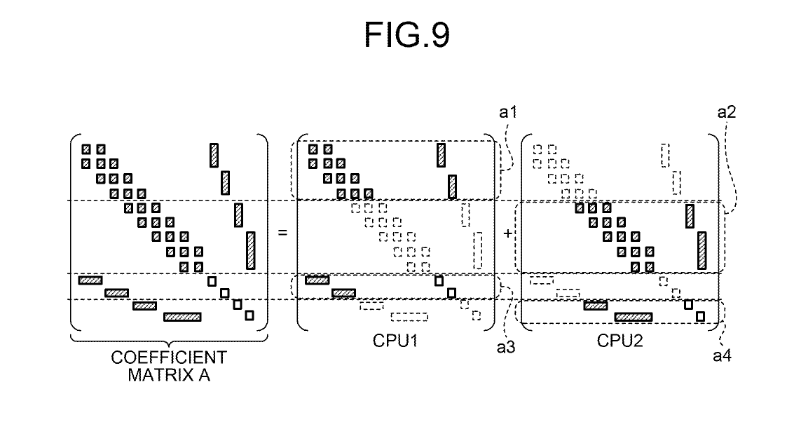

Here, an example of sharing of the coefficient matrix A among CPUs is explained with reference to FIG. 9. FIG. 9 is a diagram illustrating an example of the sharing among CPUs when performing parallel computation. FIG. 9 depicts a case where two CPUs perform parallel computation in parallel. As illustrated in FIG. 9, rectangular black-painted areas of the coefficient matrix A indicate that a value thereof is not zero. Rectangular white-painted areas and empty space of the coefficient matrix A indicate that a value thereof is zero. When two CPUs perform parallel computation in parallel, generally, the coefficient matrix A is divided into areas so that the areas have about the same number of non-zero values. A CPU 1 and a CPU 2 each process a row including rectangular black-painted areas. Here, the CPU 1 takes charge of areas a1 and a3. The CPU 2 takes charge of areas a2 and a4.

The CPUs 1 and 2 each calculate a shift parameter γ for their assigned areas. A method to calculate a shift parameter is the same as in the first embodiment; a shift parameter γ is calculated so that Dᵢᵢ, excluding ones placed in rows of which the current is the unknown quantity, are positive.

The shift-parameter sharing unit 9 acquires a shift parameter calculated with respect to each CPU by the shift-parameter calculating unit 6A, and shares the maximum shift parameter in the acquired shift parameters. That is, respective shift parameters calculated by CPUs are not always the same value. Accordingly, the shift-parameter sharing unit 9 shares the maximum shift parameter in the shift parameters calculated by the CPUs, and stores the shared shift parameter as shift parameter data 42 in the storage unit 4. By sharing the maximum value of shift parameter, the preconditioner calculating unit 7 and the iterative-solution calculating unit 8 can find a solution of a system of equations for magnetic field stably.

Incidentally, in the second embodiment, there is explained the shift-parameter calculating unit 6A in the case where two CPUs perform parallel computation in parallel. That is, the shift-parameter calculating unit 6A calculates a shift parameter to adjust assigned areas that the two CPUs take charge of, respectively, out of the coefficient matrix A so that a value of diagonal component becomes a positive value slightly larger than zero. However, the shift-parameter calculating unit 6A is not limited to this, and can be applied to a case where three or more CPUs perform parallel computation. Furthermore, the shift-parameter calculating unit 6A can be applied to a case where even if there is one CPU, multiple threads perform parallel computation by one process.

### Effects of Second Embodiment

According to the above-described second embodiment, the magnetization analyzing apparatus 1 calculates a value of shift parameter based on the binary search so that a value of a first diagonal component of a preconditioner C becomes positive. The magnetization analyzing apparatus 1 calculates a value of shift parameter based on the binary search so that a value of a second diagonal component of the preconditioner C becomes positive. The magnetization analyzing apparatus 1 shares the maximum value in the calculated values of the two parameters. According to this configuration, the magnetization analyzing apparatus 1 divides the preconditioner C into the first and second diagonal components, and calculates a shift parameter for each diagonal component, and therefore can calculate a shift parameter at high speed. Furthermore, by sharing the maximum value in the calculated values of the two parameters, the magnetization analyzing apparatus 1 can calculate a system of equations for magnetic field stably and at high speed.

[Others]

Incidentally, components of the magnetization analyzing apparatus 1 illustrated in drawings do not necessarily have to be physically configured as illustrated in the drawings. That is, the specific forms of division and integration of components of the magnetization analyzing apparatus 1 are not limited to those illustrated in the drawings, and all or some of the components can be configured to be functionally or physically divided or integrated in arbitrary units depending on various loads and usage conditions, etc. For example, the circuit-absence calculating unit 61 and the circuit-presence calculating unit 62 can be integrated as one unit. Furthermore, the storage unit 4 can be an external device connected to the magnetization analyzing apparatus 1 via a network.

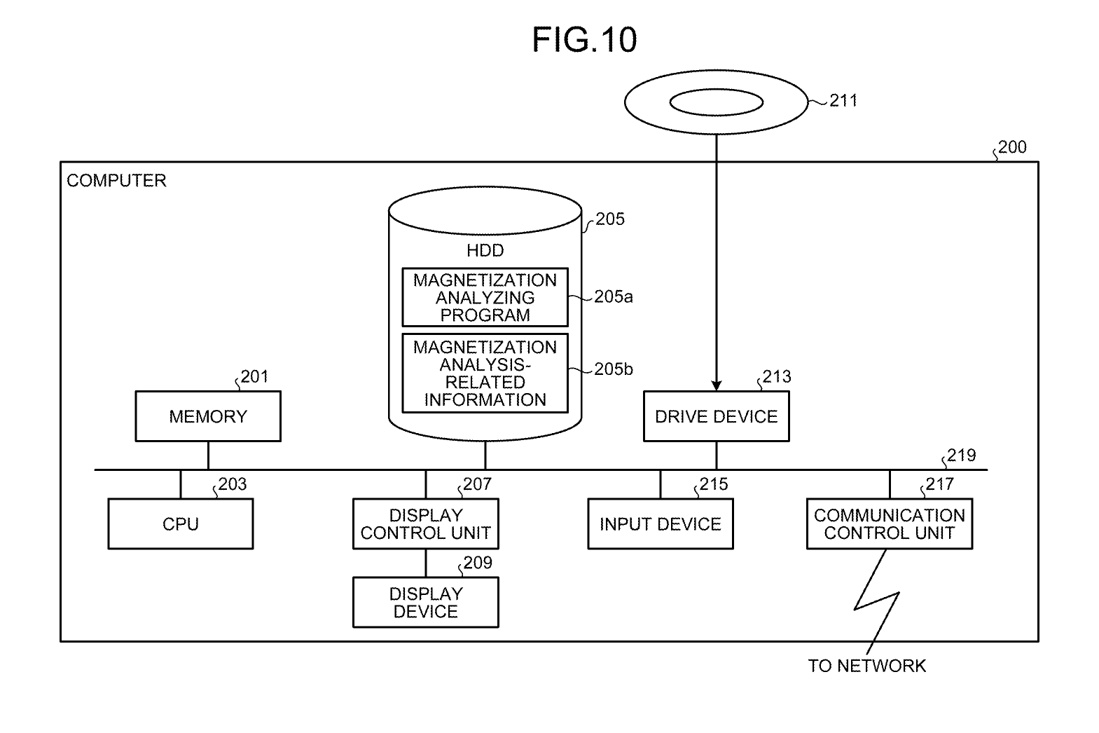

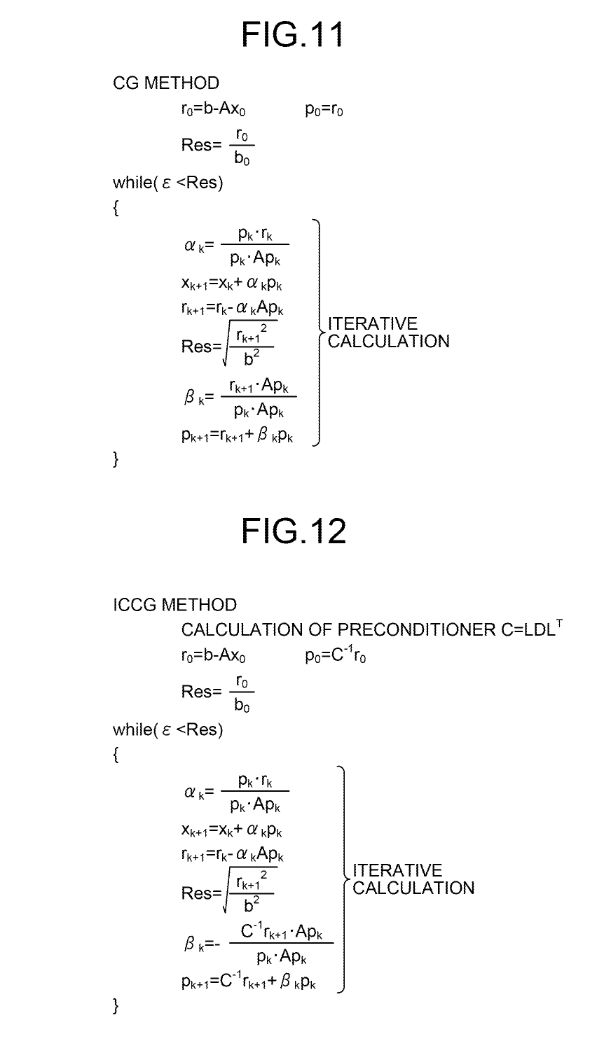

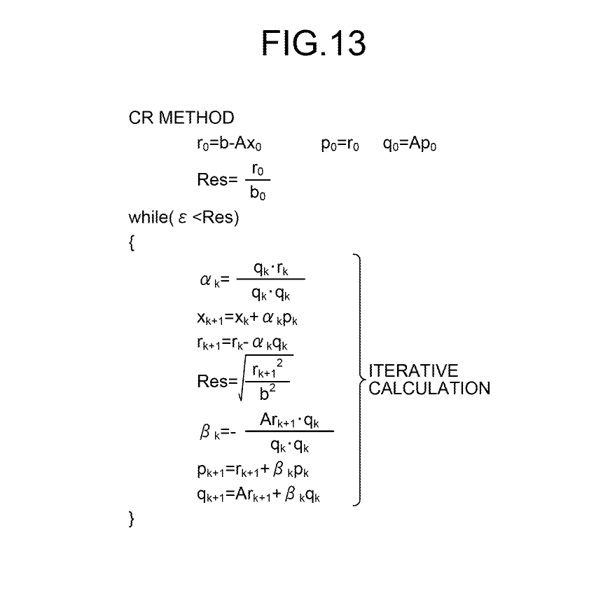

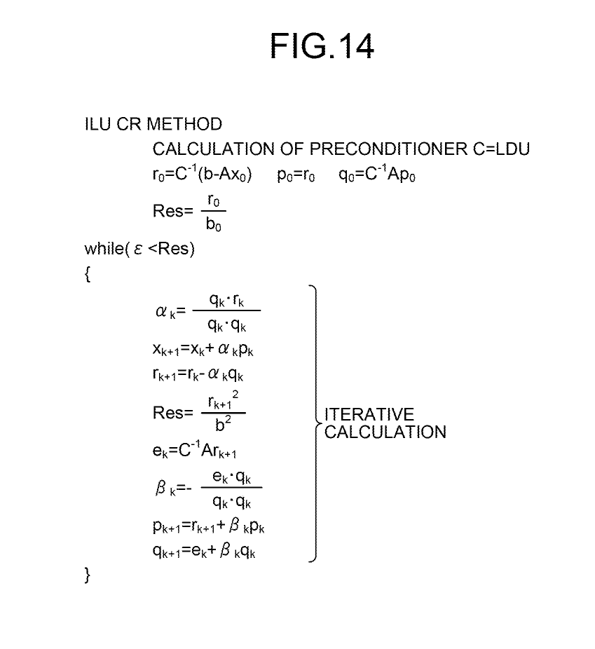

Furthermore, the various processes described in the above embodiments can be realized by causing a computer, such as a personal computer or a workstation, to execute a program prepared in advance. An example of a computer that executes a magnetization analyzing program that achieves the same functions as the magnetization analyzing apparatus 1 illustrated in FIG. 1 is explained below. FIG. 10 is a diagram illustrating an example of the computer that executes the magnetization analyzing program.

As illustrated in FIG. 10, a computer 200 includes a CPU 203 that executes various arithmetic processing, an input device 215 that receives input of data from a user, and a display control unit 207 that controls a display device 209. Furthermore, the computer 200 includes a drive device 213 that reads a program or the like from a storage medium and a communication control unit 217 that gives and receives data to/from another computer via a network. Moreover, the computer 200 includes a memory 201 that temporarily stores therein a variety of information and an HDD 205. The memory 201, the CPU 203, the HDD 205, the display control unit 207, the drive device 213, the input device 215, and the communication control unit 217 are connected by a bus 219.

The drive device 213 is, for example, a device for a removable disk 211. The HDD 205 stores therein a magnetization analyzing program 205a and magnetization analysis-related information 205b.

The CPU 203 reads out the magnetization analyzing program 205a, expands the magnetization analyzing program 205a into the memory 201, and executes the magnetization analyzing program 205a as a process. The process corresponds to the function units of the magnetization analyzing apparatus 1. The magnetization analysis-related information 205b corresponds to the calculation condition data 41, the shift parameter data 42, and the result data 43. Then, for example, the removable disk 211 stores therein information such as the magnetization analyzing program 205a.

Incidentally, the magnetization analyzing program 205a does not necessarily have to be stored in the HDD 205 from the beginning. For example, the program can be stored in a “portable physical medium”, such as a flexible disk (FD), a CD-ROM, a DVD, a magneto-optical disk, or an IC card, to be inserted into the computer 200. Then, the computer 200 can read out the magnetization analyzing program 205a from the portable physical medium and execute the read program.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetization analyzing apparatus that calculates a solution of a system of equations for magnetic field by iterative calculation, the magnetization analyzing apparatus comprising:
a processor configured to execute a process including:
acquiring a preconditioner by decomposing a coefficient matrix included in the system of equations; and
calculating a value of a parameter for adjusting values of diagonal components of the acquired preconditioner based on binary search so that values of diagonal components of the preconditioner become positive by using the parameter.

2. The magnetization analyzing apparatus according to claim 1, wherein when the system of equations includes a circuit-related system of equations, the calculating includes calculating a value of the parameter by excluding diagonal components placed in rows of a coefficient matrix related to the circuit-related system of equations.

3. The magnetization analyzing apparatus according to claim 1, wherein
the calculating includes:
first setting first and second values of the parameter in advance;
first calculating a minimum value in the values of the diagonal components of the preconditioner corresponding to an intermediate value of the set first and second values;
second calculating a difference between the set first and second values; and
second setting the intermediate value of the set first and second values as a new second value when the calculated minimum value in the values of the diagonal components of the preconditioner is larger than zero, or sets the intermediate value of the set first and second values as a new first value when the minimum value is equal to or smaller than zero, and
processing at the first calculating, processing at the second calculating, and processing at the second setting are repeated until the calculated difference becomes smaller than a predetermined threshold.

4. The magnetization analyzing apparatus according to claim 3, wherein when the calculated difference is smaller than the predetermined threshold, the calculating includes calculating, as a value of the parameter, a value obtained by multiplying a value in between the set first value and the set second value by a value obtained by adding a value of an adjustment parameter to 1.

5. The magnetization analyzing apparatus according to claim 3, wherein the calculating includes calculating the predetermined threshold by using a linear equation for a variable set as the adjustment parameter in advance.

6. The magnetization analyzing apparatus according to claim 1, wherein
the calculating includes:
first calculating a value of the parameter based on the binary search so that a value of a first diagonal component of the acquired preconditioner becomes positive; and
second calculating a value of the parameter based on the binary search so that a value of a second diagonal component of the acquired preconditioner becomes positive, and
the calculating includes sharing a maximum value in the value of the parameter calculated at the first calculating and the value of the parameter calculated at the second calculating.

7. A magnetization analyzing method comprising:
acquiring a preconditioner by decomposing a coefficient matrix included in a system of equations for magnetic field, by a processor; and
calculating a value of a parameter for adjusting values of diagonal components of the acquired preconditioner based on binary search so that values of diagonal components of the preconditioner become positive by using the parameter, by the processor.

8. A non-transitory computer-readable recording medium storing a magnetization analyzing program that causes a computer to execute a process comprising:
acquiring a preconditioner by decomposing a coefficient matrix included in a system of equations for magnetic field; and
calculating a value of a parameter for adjusting values of diagonal components of the acquired preconditioner based on binary search so that values of diagonal components of the preconditioner become positive by using the parameter.
